(19) United States
(12) Patent Application Publication
(10) Pub. No.: US 2014/0260244 A1
(43) Pub. Date: Sep. 18, 2014

(54) CENTRIFUGAL SUPERCHARGER AND SUPERCHARGING SYSTEM FOR ENGINE USING THE SAME

(71) Applicants: Kia Motors Corporation, Seoul (KR); Hyundai Motor Company, Seoul (KR)

(72) Inventors: Jin Wook SON, Suwon-si (KR); Jin Kook KONG, Suwon-si (KR); Ju Hun LEE, Gwangmyung-si (KR); Byeong Seok LEE, Hwaseong-si (KR); Young Nam KIM, Seongnam-si (KR); Jeong Hwa CHA, Incheon-si (KR)

(73) Assignees: Kia Motors Corporation, Seoul (KR); Hyundai Motor Company, Seoul (KR)

(21) Appl. No.: 14/137,271

(22) Filed: Dec. 20, 2013

(30) Foreign Application Priority Data
Mar. 15, 2013 (KR) 10-2013-0027957

(51) Int. Cl. F02B 33/40

(52) U.S. Cl. CPC F02B 33/40
USPC 60/609; 123/559.3

(57) ABSTRACT

A centrifugal supercharger includes, a drive pulley connected to receive rotating power from an engine. an electronic blocking the rotating power to be supplied to the drive pulley or supplying the rotating power to the drive pulley. a speed increasing device increasing rotation speed of the drive pulley. a compressor including an impeller receiving rotation power having speed increased by the speed increasing device and flowing and compressing external air and an impeller housing.

### CROSS-REFERENCE TO RELATED APPLICATION

The present application claims priority to Korean Patent Application No. 10-2013-0027957 filed on Mar. 15, 2013, the entire contents of which is incorporated herein for all purposes by this reference.

### BACKGROUND OF THE INVENTION

1. Field of the Invention

The present invention relates to a centrifugal supercharger using an electronic clutch and a speed increasing device and a supercharging system for an engine using the same.

2. Description of Related Art

In general, after introducing external air, a vehicle mixes the air with a fuel to supply a mixture to an engine, and the engine combusts the mixture of the fuel and the air to obtain power necessary to drive the vehicle.

During a procedure of generating the power by driving of the engine, when the external air must be sufficiently supplied for combustion, a desired output of the engine is obtained. Accordingly, in order to improve the output of the engine, a supercharger or a turbo charger for supplying combustion air by pressurizing the combustion air has been applied to the vehicle.

The supercharger compresses air supplied to the engine using pressure of gas exhausted from the engine.

In recent years, in order to reduce fuel consumption according to increase in oil prices and to respond to restriction of exhaust gas, a downsizing engine (supercharging engine) is gradually increased and applied to the vehicle.

A turbo charger is significantly applied to a gasoline engine to generate high torque with small exhaust amount, and to significantly improve high speed and grade ability, vehicle drivability is deteriorated due to turbo lag occurring at low speed acceleration.

In order to prevent the above turbo lag, and to improve acceleration responsiveness, a supercharger for driving a compressor using power of an engine to compress and supply intake air has been recently applied to the vehicle.

Since the supercharger has a structure simpler than a structure of the turbo charger, and rotates according to rotation of an engine, the supercharger is advantageous in that responsiveness is excellent, and maintenance and management are easy.

Among superchargers, a volume type supercharger has an advantage that vehicle acceleration responsiveness is excellent at low speed and medium speed of an engine, but has drawbacks that a volume is large, a production cost is high, and power loss occurs during engine low load operation of a normal speed running condition of a vehicle.

Among superchargers, a centrifugal supercharger has advantages that acceleration responsiveness is high and production cost is low, but has drawbacks that power loss occurs during a low load operation of the engine and operation efficiency is ensured at only a high speed region greater than thirty thousand rpm.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a centrifugal supercharger and a supercharging system for an engine using the same having advantages of improving fuel consumption by reduce driving loss, of improving acceleration responsiveness by sufficiently supercharging during acceleration, and of reducing a production cost by simplifying a structure.

In an aspect of the present invention, a centrifugal supercharger may include a drive pulley configured to receive rotating power from an engine, an electronic clutch configured for blocking the rotating power of the engine to be supplied to the drive pulley or supplying the rotating power to the drive pulley, a speed increasing device coupled to the drive pulley and increasing rotation speed of the drive pulley, and a compressor including an impeller engaged to the speed increasing device and receiving rotation power having speed increased by the speed increasing device and flowing and compressing external air, and an impeller housing containing the impeller therein.

The speed increasing device may have a gear ratio in a range of 5 to 10.

A diameter of the drive pulley is set such that the drive pulley is rotated 1.5 times to 3 times when a pulley of the engine is rotated by one turn.

Speed of the impeller of the compressor is increased to may have a total speed increasing ratio in a range of 10 to 25 through a pulley ratio and a gear ratio and the impeller of the compressor is rotated.

The speed increasing device may include a drive gear mounted at a drive shaft connected to the drive pulley, and a driven gear mounted at a driven shaft and engaged with the drive gear.

The drive gear and the driven gear may include a helical gear.

A plurality of impellers is circumferentially disposed on a base plate at a predetermined angle and extend radially, and an outlet angle of the impellers may have an angle in a range of 0° to 10°.

When the engine operates below a predetermined speed and below a predetermined load, the electronic clutch is released, when the engine operates below a predetermined speed and above the predetermined load, the electronic clutch is connected, and when the engine operated above a predetermined speed, the electronic clutch is released.

A supercharging system for the engine may include the centrifugal supercharger and a turbo charger compressing and supplying the external air to the engine using pressure of air exhausted from the engine.

The engine is mounted together with an automatic transmission.

According to a centrifugal supercharger and a supercharging system for an engine using the same of an exemplary embodiment of the present invention, supercharging pressure is sufficiently supplied in an operation region from 2,000 rpm to 3,000 rpm being a practical operation region of the engine to improve an output of the engine by applying a speed increasing device using a high ratio helical gear.

Further, by applying an electronic clutch, power to the supercharger is blocked in a low load operation of the engine to prevent power loss, thereby improving fuel consumption. During a high speed operation of the engine, power may be blocked to prevent damage or breakage of the supercharger.

Moreover, an outlet angle of a compressor blade is applied to 10° or lower so that supercharging pressure can be improved.

In addition, a centrifugal supercharger and a supercharging system for an engine can be manufactured at low cost to have a simple structure, and driving noise can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating a supercharging system for an engine using a centrifugal supercharger according to an exemplary embodiment of the present invention.

FIG. 2 is a partially cut cross-sectional view illustrating centrifugal supercharger according to an exemplary embodiment of the present invention.

FIG. 3 is a perspective view illustrating a compressor impeller of the centrifugal supercharger according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

Referring to FIG. 1, an intake passage 20 flowing external air is connected to a cylinder 10 of an engine forming a combustion chamber, and an intercooler 30 cooling and supplying compressed air is installed at the intake passage 20.

A supercharger 40 flowing, compressing, and supplying the external air through the intake passage 20 is connected to the intercooler 30, a bypass passage 50 bypassing the supercharger 40 is formed at a front end and a rear end of the supercharger 40, and a bypass valve 60 is installed at the bypass passage 50 to open and close the bypass passage 50.

The supercharger 40 may be connected to a power transmission device such as a belt which is not shown so that the super charger 40 may receiver rotation power from the engine to be driven.

The supercharger 40 and a turbo charger constitute a supercharging system for an engine. In this case turbo charger operates according to pressure of gas exhausted from the engine to flow, compress, and supply external air to the engine.

Referring to FIG. 2, the supercharger 40 includes an impeller housing 41 having an inlet 41a flowing the external air and an outlet 41b exhausting compressed air.

An impeller 42 is integrally mounted with a driven shaft 43 inside the housing 41.

The impeller housing 41, the impeller 42, and the driven shaft 43 constitute a compressor.

A driven gear 44 is mounted at the driven shaft 43, and the driven gear 44 engages with a drive gear 45.

The driven gear 44 and the drive gear 45 constitute a gear type speed increasing device.

The driven gear 44 and the drive gear 45 may be configured by a helical gear, respectively.

The driven gear 44 and the drive gear 45 have a proper gear ratio.

For example, the driven gear 44 and the drive gear 45 may have gear teeth so that a gear ratio of gear teeth of the driven gear 44 to gear teeth of the drive gear 45 is 1:10. Meanwhile, the driven gear 44 and the drive gear 45 may have gear teeth so that a gear ratio of gear teeth of the driven gear 44 to gear teeth of the drive gear 45 is 1:5˜15.

That is, when the drive gear 45 is rotated by one turn, the gear ratio is formed so that the driven gear 44 is rotated 5 times to 15 times.

The drive gear 45 is rotatably mounted at the drive shaft 46.

A belt pulley 47 serving as a drive pulley is installed at a front portion of the drive shaft 45, and the belt pulley 47 may be connected to a pulley of the engine to receive rotating power from the engine through a belt which is not shown.

The belt pulley 47 may include a known electronic clutch.

In the electronic clutch, when a control signal is applied, a clutch is separated or connected, the belt pulley 47 may selectively receive rotating power from the engine through the electronic clutch.

For example, when the engine operates with low speed and low load, a controller applies a control signal to the electronic clutch to release the electronic clutch. Accordingly the engine does not transfer the power to the supercharger, and power loss of the engine due to the supercharger is prevented, thereby improving fuel consumption.

Meanwhile, when the engine operates with low speed and high load, the controller blocks the control signal applied to the electronic clutch to connect the electronic clutch. Accordingly the power of the engine is transferred to the supercharger to operate the supercharger, and compressed air is supercharged to the engine by operation of the supercharger so that driving force of the engine may be improved and turbo lag may be prevented.

Further, when the engine operated with high speed, for example, speed of 3,000 rpm or higher, the controller applies the control signal to the electronic clutch to release the electronic clutch. Accordingly, the power of the engine is not transferred to the supercharger, and the supercharger cannot be damaged or broken due to high speed rotation (about 60,000 rpm or higher).

A diameter of the belt pulley 47 may be set so that the belt pulley 47 is rotated 1.5 to 3 times when a pulley of the engine is rotated by one turn.

Accordingly, when the pulley of the engine is rotated by one turn, the impeller 42 is rotated by about 8 turns to 45 turns with increased speed through a speed increasing ratio and a gear ratio of the belt pulley 47.

Preferably, the speed of the impeller 42 is increased to 10 times to 25 times.

Supercharging pressure of the supercharger may be sufficiently generated due to the above high speed increase.

Particularly, when the supercharge according to an exemplary embodiment of the present invention is applied to the vehicle having an automatic transmission, the speed of the engine is increased to about 2,400 rpm during acceleration. In this case, when the supercharger is driven with about 20 times higher than the rotation speed of the engine, supercharging pressure may be increased to an appropriate level to prevent turbo lag and to improve an output and responsiveness of the engine.

Referring to FIG. 3, a plurality of impellers 42 are disposed on a base plate 42a having a disc shape connected to the driven shaft 43 while being circumferentially spaced apart from each other and extending radially.

An outlet angle of the impeller 42 may have an angle in the range of 0° to 10°.

If the outlet angel of the impeller 42 is reduced, supercharging pressure is increased but efficiency is deteriorated. When the outlet angel of the impeller 42 is increased, the supercharging pressure is reduced but the efficiency is increased.

The outlet angle of the impeller 42 may have an angle in the range of 0° to 10° so that the supercharging pressure is increased to the highest degree.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A centrifugal supercharger comprising:
a drive pulley configured to receive rotating power from an engine;
an electronic clutch configured for blocking the rotating power of the engine to be supplied to the drive pulley or supplying the rotating power to the drive pulley;
a speed increasing device coupled to the drive pulley and increasing rotation speed of the drive pulley; and
a compressor including:
an impeller engaged to the speed increasing device and receiving rotation power having speed increased by the speed increasing device and flowing and compressing external air; and
an impeller housing containing the impeller therein.

2. The centrifugal supercharger of claim 1, wherein the speed increasing device has a gear ratio in a range of 5 to 10.

3. The centrifugal supercharger of claim 2, wherein a diameter of the drive pulley is set such that the drive pulley is rotated 1.5 times to 3 times when a pulley of the engine is rotated by one turn.

4. The centrifugal supercharger of claim 1, wherein speed of the impeller of the compressor is increased to have a total speed increasing ratio in a range of 10 to 25 through a pulley ratio and a gear ratio and the impeller of the compressor is rotated.

5. The centrifugal supercharger of claim 1, wherein the speed increasing device comprises:
a drive gear mounted at a drive shaft connected to the drive pulley; and
a driven gear mounted at a driven shaft and engaged with the drive gear.

6. The centrifugal supercharger of claim 5, wherein the drive gear and the driven gear comprise a helical gear.

7. The centrifugal supercharger of claim 1, wherein a plurality of impellers are circumferentially disposed on a base plate at a predetermined angle and extend radially, and an outlet angle of the impellers has an angle in a range of 0° to 10°.

8. The supercharging system of claim 1, wherein when the engine operates below a predetermined speed and below a predetermined load, the electronic clutch is released, when the engine operates below a predetermined speed and above the predetermined load, the electronic clutch is connected, and when the engine operated above a predetermined speed, the electronic clutch is released.

9. A supercharging system for the engine comprising:
the centrifugal supercharger of claim 1; and
a turbo charger compressing and supplying the external air to the engine using pressure of air exhausted from the engine.

10. The supercharging system of claim 9, wherein the engine is mounted together with an automatic transmission.
